(19) United States
(12) Patent Application Publication
(10) Pub. No.: US 2002/0117614 A1
(43) Pub. Date: Aug. 29, 2002

(54) Methods and devices for measuring radiation using luminescence

(75) Inventors: Brian Robert More, Salwick (GB); Thomas Stephen Nobes, Salwick (GB); Sven Glyn Roden, Salwick (GB); Graham John Wilson, Salwick (GB); John Brian Wright, Salwick (GB); David Arthur Andrews, Manchester (GB); Benjamin Matthew William Bradford, Manchester (GB)

Correspondence Address: BEYER WEAVER & THOMAS LLP, P.O. BOX 778, BERKELEY, CA, 94704-0778, US

(73) Assignee: British Nuclear Fuels PLC

(21) Appl. No.: 10/095,623

(22) Filed: Mar. 11, 2002

Related U.S. Application Data
(63) Continuation of application No. 09/463,585, filed on May 15, 2000, now abandoned.
Application No. 09/463,585 is a 371 of international application No. PCT/GB98/02106, filed on Jul. 27, 1998.

(30) Foreign Application Priority Data
Jul. 26, 1997 (GB) 9715767.1

(51) Int. Cl. H01J 49/00; B01D 59/44; H01J 49/40

(52) U.S. Cl. 250/281; 250/282; 250/286

(57) ABSTRACT

A system for criticality incident detection is described. The system comprises a plurality of sensors at least partially comprised of storage phosphors. The sensors are distributed throughout the environment to be monitored. The sensors are coupled to a central detection system comprised of at least a luminescence detector and a processor. The luminescence detector measures the luminance of the sensors and provides that measurement to the processor. The processor then calculates the radiation level that the luminance measurement corresponds to. In other embodiments, monitoring units are installed in various portions of the environment being monitored. The monitoring units accept the sensors and are coupled to the central detection system so that the remote monitoring units can be interrogated from the central detection system.

This invention relates to methods and devices for measuring radiation, including criticality incident detector sensors, personal dosimeters, remote monitors and area monitors.

Monitoring of radiation is required in a great variety of situations, and a wide variety of techniques exist. In the nuclear industry there are needs for long term monitoring of locations, remote monitoring of locations and personal dose monitoring, aswell as detection systems for criticality incidents.

A criticality incident results in an uncontrolled and unwanted release of radiation to which personnel and areas may be exposed. It is desirable to detect such occurrences and provide an alarm indication when they occur. In general, a criticality event causes a rapid increase of ionised radiation and the alarm system is triggered by this initial burst of radiation to sound emergency evacuation alarms. Whilst such alarms are known, for instance using Geiger Müller tubes as critical incident detection sensors, the amount of information they provide surrounding the event is very limited. Müller tube systems are appropriate for detecting a criticality incident, but they are not able to provide information relating to the level, variation and timing of radiation to which different personnel may have been exposed during the criticality incident. This lack of information necessitates investigations using other instruments or, in many instances, the acceptance of the non-availability of that information.

The present invention also relates to a device for use in measuring exposure to radiation of personnel working, for example, under normal conditions in a nuclear power station or as hospital staff, administering X-rays or other types of radiation to patients. Such a device is known as a dosemeter or dosimeter. Existing photographic film type badges offer single use dosemeters, but are Limited in their range and versatility of operation, aswell as facing problems with accidental light exposure.

Existing systems for other monitoring and/or detecting applications are known, but equally face problems in their use, reliability or versatility.

The present invention aims to provide a range of radiation detecting and monitoring methods, systems and devices, primarily through the manner of use of storage phosphors.

Storage phosphors are known in crystallography and medical imaging as a way of storing incident radiation, as an image. Quite sometime after exposure the phosphor can be processed to recover the image. The image may be recovered gradually by interrogating small discrete areas on the phosphor with incident light to trigger light emission by that area of the phosphor. As a result the image is recovered on a pixel by pixel basis, with the location of the light emissions being all important in revealing the image in the initially incident radiation.

According to a first aspect of the invention we provide a method of detecting radiation, the method comprising exposing a stimulable phosphor material to an environment, the environment potentially containing radiation, detecting luminescence arising from the stimulable phosphor and determining the amount of radiation incident on the stimulable phosphor material from the detected luminescence.

According to a second aspect of the invention we provide a radiation detector the detector comprising a stimulable phosphor material, the detector further comprising or being adapted to cooperate with, luminescence detector means, the detector further comprising, or being adapted to cooperate with, processing means for determining the amount of radiation incident on the stimulable phosphor material from the luminescence detected and arising from the stimulable phosphor.

The luminescence may comprise or consist of spontaneous luminescence. An instantaneous determination of the amount of incident radiation may be determined in this way.

The luminescence may comprise or consist of stimulated luminescence, preferably due to stimulation provided by the detector or means with which the detector cooperates. A time delayed determination of the amount of incident radiation may be provided in this way.

Preferably spontaneous and stimulated luminescence are detected, most preferably as substantially separate stages.

The amount of radiation detected is preferably the total amount of incident radiation.

According to a third aspect of the invention we provide a method of detecting radiation, the method comprising exposing a stimulable phosphor material to an environment, the environment potentially containing radiation, detecting spontaneous luminescence arising from the stimulable phosphor and determining a function of the radiation incident on the stimulable phosphor material at the time of the spontaneous luminescence from the detected spontaneous luminescence and further comprising stimulating the phosphor material to cause stimulated luminescence and detecting the stimulated luminescence arising from the stimulable phosphor and determining a function of the amount of radiation incident on the stimulable phosphor material from the detected stimulated luminescence.

According to a fourth aspect of the invention we provide a radiation detector, the detector comprising a stimulable phosphor material, the detector further comprising, or being adapted to cooperate with, luminescence detector means for detecting spontaneous luminescence arising from the stimulable phosphor, the detector further comprising, or being adapted to cooperate with, processing means for determining a function of the radiation incident on the stimulable phosphor material at the time of the spontaneous luminescence from the detected spontaneous luminescence, the detector further comprising, or being adapted to cooperate with, phosphor material stimulating means, to cause stimulated luminescence, and luminescent detector means for detecting the stimulated luminescence arising from the stimulable phosphor, and the detector further comprising, or being adapted to cooperate with, processing means for determining a function of the amount of radiation incident on the stimulable phosphor material from the detected stimulated luminescence.

An instantaneous determination relating to the incident radiation and a time delayed determination relating to the incident radiation between stimulations may be provided in this way.

Preferably the function relates to the amount of the instantaneously incident and/or to the amount of incident radiation between stimulations. Most preferably the total amount of radiation is determined

The preceding and/or following aspects of the invention may include the following possibilities and options.

The detector may be exposed by providing at least a part of the detector, such as a detecting component or sensor, in the environment in question.

The detector may include one or more detecting components or sensors containing the stimulable phosphor. The one or more detecting components or sensors may share luminescence detecting means and/or processing means.

The detector, and/or component(s) /sensor(s) forming a part thereof, may be provided in fixed position relative to the environment, for instance on a building or item of equipment. The detector, and/or component(s)/sensor(s) forming a part thereof, may be provided in a non-fixed position, for instance on a person or on a moving or moveable piece of equipment.

The component(s)/sensor(s) may be provided at separate location(s) to the luminescence detecting means and/or processing means. The separate locations may be separated by radiological shielding.

The stimulable phosphor may be any material which luminesces in response to incident gamma and/or beta and/or neutron radiation and/or which provides a record of incident gamma and/or beta and/or neutron radiation, the record producing luminescence in response to stimulation. The use of storage phosphors is particularly preferred.

The environment may be any location in which radiation is expected or might be encountered. Environments include, but are not limited to, rooms, cells, chambers and equipment, for instance, on nuclear processing facilities, nuclear storage facilities, nuclear power installations and medical centres.

The radiation may comprise one or more of alpha, beta, gamma, ultraviolet, X-ray or neutron radiation.

The luminescence detecting means are preferably the same for spontaneous and stimulated luminescence.

The luminescence detecting means may be provided as an integral part of the device and/or may be provided as a separate unit. When provided as an integral unit radiation detection can be provided on command to the user. The luminescence detecting means may be provide physically remote from the detector/sensor, even when integrally provided. When provided as a separate unit radiation detection can be provided on connecting the device to the unit.

A central luminescence detecting means may be provided for a plurality of devices and/or for a plurality of detecting components/sensors.

The luminescence detecting means preferably comprises a light detector and means for conveying light from the phosphor to the light detector.

The light conveying means may comprise one or more of single optical fibres, multiple optical fibres, mirror and lens systems, mirrors, hollow waveguides, articulated arms, light guides and direct line of sight between the phosphor and the detector. Separate light conveying means may be provided for each detecting component/sensor.

The light detector may comprise one or more of photo-multiplier tubes, photo diodes, photocells, photovoltaic cells, phototransistors, photo resistors, charged coupled devices and pyro-electric detectors. Separate light detecting means may be provided for each detecting component/sensor. The luminescence of individual detector components/sensors may be detected separately, for instance through a light detector which is exposed to light from the different detector components/sensors at different times.

The processing means are preferably the same for spontaneous and stimulated luminescence based determinations.

The processing means may be provided as an integral part of the device and/or may be provided as a separate unit. The processing means may be provide physically remote from the detector/sensor even when integrally provided. A central processing means may be provided for a plurality of devices and/or for a plurality of detector components/sensors.

The processing means may calculate a function of the incident radiation based on the level of luminescence detected. The luminescence detected may be the level of spontaneous luminescence and/or the total luminescence output as a result of stimulation. The processing means may calculate dose and/or effective dose.

The function of the incident radiation may be compared with a threshold value. If a threshold value is exceeded at a given time then an alarm may be triggered. The exceeding of the threshold may correspond to a criticality event.

The function of the incident radiation may be compared with a reference value or historical profile. Particular variations relative to the reference value and/or historical profile may trigger an alarm. The variation may be equated with a gradual change in the environment being monitored with time.

The stimulating means may be provided as an integral part of the device and/or may be provided as a separate unit. When provided as an integral unit radiation detection can be provided on command to the user. The stimulating means may be provide physically remote from the detector/sensor even when integrally provided. When provided as a separate unit radiation detection can be provided on connecting the device to the unit.

A central stimulating means may be provided for a plurality of devices and/or for a plurality of detecting components/sensors.

The stimulating means may be optical and/or thermal.

Optical stimulating means may comprise one or more of a diode laser, a solid state laser, a dye laser, a gas laser, a chemical laser, an excimer laser, light emitting diodes, incandescent light bulbs, discharge lamps, arc lamps and luminous chemical reaction sources. The optical stimulating means may be connected to the stimulable phosphor. Connection may be provided by optical fibre. The connection may, at least in part, be common with the connection of the detecting component(s)/sensor(s) to the luminescence detecting means.

Thermal stimulating means may comprise one or more of an electrical heating element, electrical heating/resistance elements, microwave heating devices, radiofrequency heating devices and infra red heating devices.

In a preferred embodiment of the invention, with particular emphasis on criticality incident monitoring, a plurality of locations within the environment are provided with detecting components/sensors, the detecting components/sensors being connected to luminescence detecting means for monitoring spontaneous luminescence, stimulation means being connected to the plurality of detecting components/sensors, the luminescence detecting means also monitoring stimulated luminescence. It is particularly preferred that spontaneous luminescence above a threshold value trigger an alarm.

The invention may be used to provide fixed monitoring of an environment on a permanent basis, or to provide temporary monitoring, for instance during decommissioning.

It is preferred that the output from the detecting components/sensors be considered individually. The individual results from the detecting components/sensors may be used to calculate a spatial distribution of the incident radiation or other characteristic, according to the spatial distribution of the detecting components/sensors. Contour plots and/or 2-D and/or 3-D plots may be used to present the spatial information.

In an alternative preferred embodiment of the invention, with particular emphasis on dosimeters, the stimulable phosphor is provided in a container carried by a person or on an item, the incident radiation on the phosphor being monitored by introducing the container to a monitoring unit, the monitoring unit providing means for stimulating the stimulable phosphor and means for detecting luminescence from the phosphor. The total luminescent output from the phosphor is measured in such cases, irrespective of the position on the phosphor from which that luminescence arises.

The monitoring unit may comprise a monitoring station connected to a central processing location and/or central data storage location and/or central control location. A plurality of containers may be monitored by such a monitoring unit simultaneous and/or sequentially. A plurality of monitoring units may be provided in such a system.

One or more monitoring units may be provided at a location remote to the devices use, for instance an evacuation location. The monitoring units may be used to investigate incident radiation on devices arriving at the evacuation location. The results of the monitoring may be used to determine the subsequent action applied to the personnel carrying the respective devices.

A monitoring unit may provide for access control to a location. Access may be controlled according to the output from the phosphor and/or according to stored information in the monitoring unit and/or central unit. Access may be denied where the output and/or total consideration exceeds a threshold value.

The monitoring unit may comprise a portable monitoring unit. The monitoring unit may be carried by a user. Preferably the monitoring unit provides for monitoring of spontaneous luminescence. Thus an individual criticality incident monitor may be provided. Preferably the monitoring unit provides for monitoring of stimulated luminescence. Thus radiation dose monitoring may be provided. The incident radiation may be investigated periodically and/or upon command, by stimulating the phosphor using the stimulating means in the monitoring unit.

A system may be provided incorporating one or more of the above mentioned monitoring units.

The invention may additionally or alternatively be provided according to one or more of the following aspects of the invention The features, options and possibilities set out for all the aspects of the invention, and set out elsewhere, are interchangeable, individually.

According to a fifth aspect of the present invention there is provided a radiation detection and measuring device comprising sensor means for sensing levels of radiation emitted over a period of time and storing information relating to the levels of radiation emitted, whereby the information may be retrieved some time after the radiation has been emitted, thereby providing detailed information relating to levels of radiation emission over a period of time.

According to a sixth aspect of the present invention there is provided a radiation detection and measuring device comprising sensor means, the sensor means comprising storage phosphors, which sensor means is adapted to detect an initial burst of radiation, store information relating to the level of the initial burst of radiation, and measure and store subsequent levels of radiation thereby providing information relating to the fluctuations in the levels of radiation which information may be retrieved from the device after the radiation emission has occurred

According to a seventh aspect of the present invention there is provided a radiation detecting and measuring device comprising:

sensor means comprising a storage phosphor;

detection means for detecting spontaneous luminescence of the storage phosphor thereby providing real-time information relating to occurrence of and/or levels of radiation emission.

According to a eighth aspect of the present invention there is provided a radiation detection and measuring device comprising:

sensor means comprising a storage phosphor;

stimulating means for stimulating the sensor; and

detection means for detecting signals emitted from the sensor after stimulation.

By means of the present invention, therefore, storage phosphors may be used: to detect a critical incident and to trigger alarm in the event of such a critical incident; and/or to provide information relating to the levels of radiation emitted over a period of time during a criticality event and/or after that event has occurred.

A variety of storage phosphors may be used in the present invention, including storage phosphors in which the phosphor is incorporated as a poly crystalline powder with an organic binder in a polymer film and/or where the storage phosphor material is contained within a host matrix which comprises a sol-gel derived matrix in which the storage phosphor is incorporated, most preferably as a dopant. Such storage phosphor materials provide better optical coupling to read out systems for reading out stored information, for example, photo stimulation and photo emission systems, and give better optical absorption characteristics of the luminescence radiation and provide a host material with better mechanical rigidity and thermal and chemical stability.

The sensor means may comprise a single type of storage phosphor, or alternatively, the sensor means may comprise a number of different storage phosphors and/or a blend of storage phosphors. It may be advantageous to use a blend of phosphors depending on the circumstances under which the device will be used. A blend of storage phosphors will have different characteristics to a single storage phosphor. The required characteristics may be achieved by appropriate mixing of the blend of phosphors.

Preferably, the device further comprises an alarm system, and triggering means for triggering the alarm system when the signal detected by the detection means from the sensor is above a predetermined level.

In the event of a criticality incident in a nuclear facility, the storage phosphor will luminesce by the absorption of some radiation from the criticality incident. This will lead to spontaneous luminescence of the storage phosphor. The spontaneous luminescence will be detected by the detection means. Preferably this in turn will cause the trigger means to trigger the alarm system because the level of luminescence is above a predetermined level. The alarm system will alert personnel to the criticality incident ensuring that the area in which the criticality incident has occurred is cleared as soon as possible.

Advantageously, the device further comprise stimulating means for stimulating storage phosphors causing the storage phosphors to luminesce. When storage phosphors are exposed to radiation below a predetermined level, electrons will be excited and trapped as described herein. The number of electrons excited and trapped is used by the present invention as a measure of the intensity of the incident radiation. By stimulating the storage phosphors after exposure to incident radiation, photons will be released due to the fact that the trapped electrons are photo stimulated. The intensity of light output emitted by stimulated storage phosphors provide information relating to the levels of radiation to which the storage phosphor had been exposed.

Conveniently, the stimulating means is an optical source, for example, a laser. Other examples of appropriate optical sources are arc lamps, filament lamps, light emitting diodes and discharge lamps.

Alternatively the stimulating means could be a heat source such as a local heat source, for example, an electrical heating element. Other examples of suitable heating elements are electrical heating/resistance elements, microwave heating devices, and infra red heating devices.

Preferably, the detection means comprises a photosensitive device. The photo sensitive device may comprise a photo multiplier tube, a photo diode, a charged coupled device or an avalanche photodiode.

Various embodiments of the intention will now be further described, by way of example only, with reference to the accompanying drawings in which:

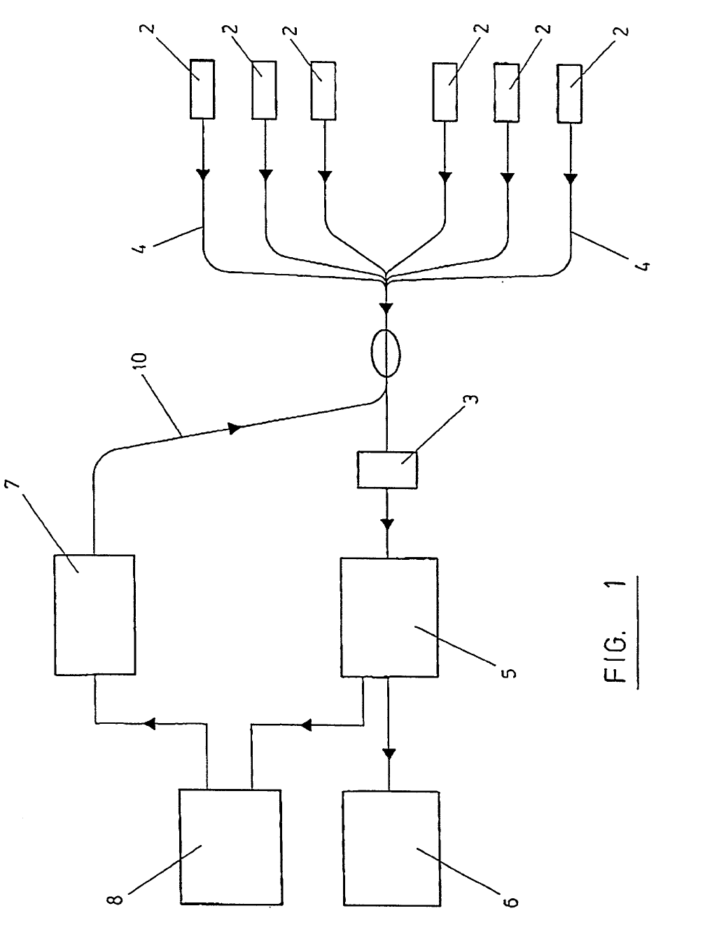

FIG. 1 is a schematic representation of a system incorporating a device according to the present invention and suitable for detecting criticality incidents,

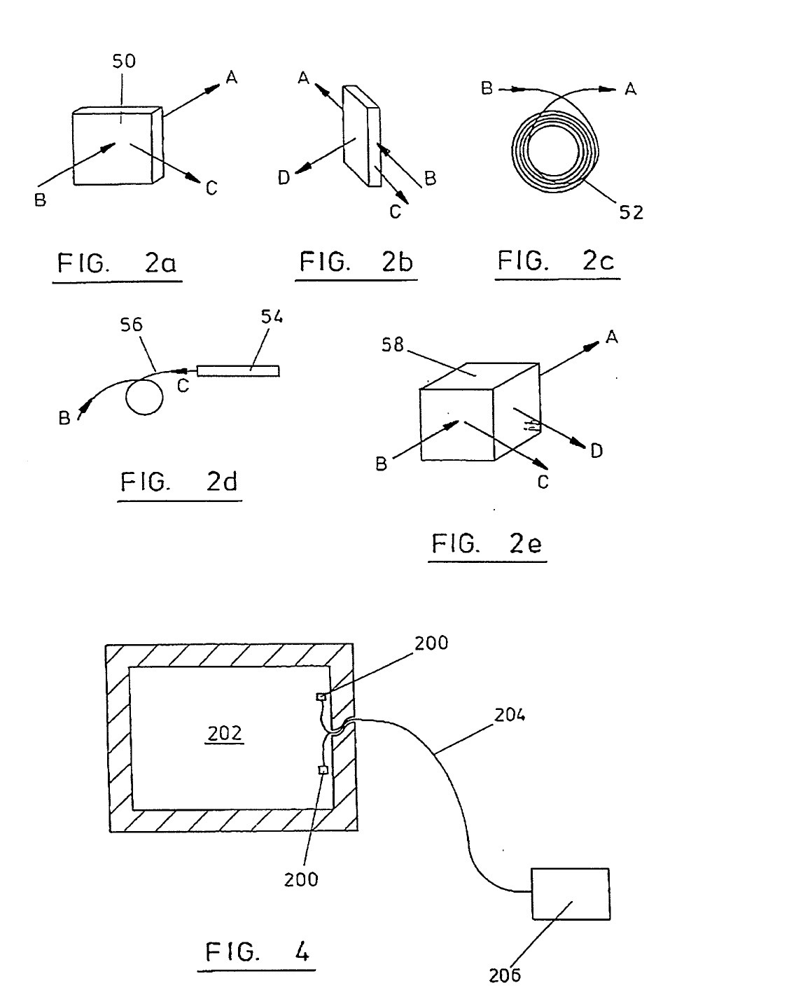

FIG. 2a to 2e illustrate potential storage phosphor forms;

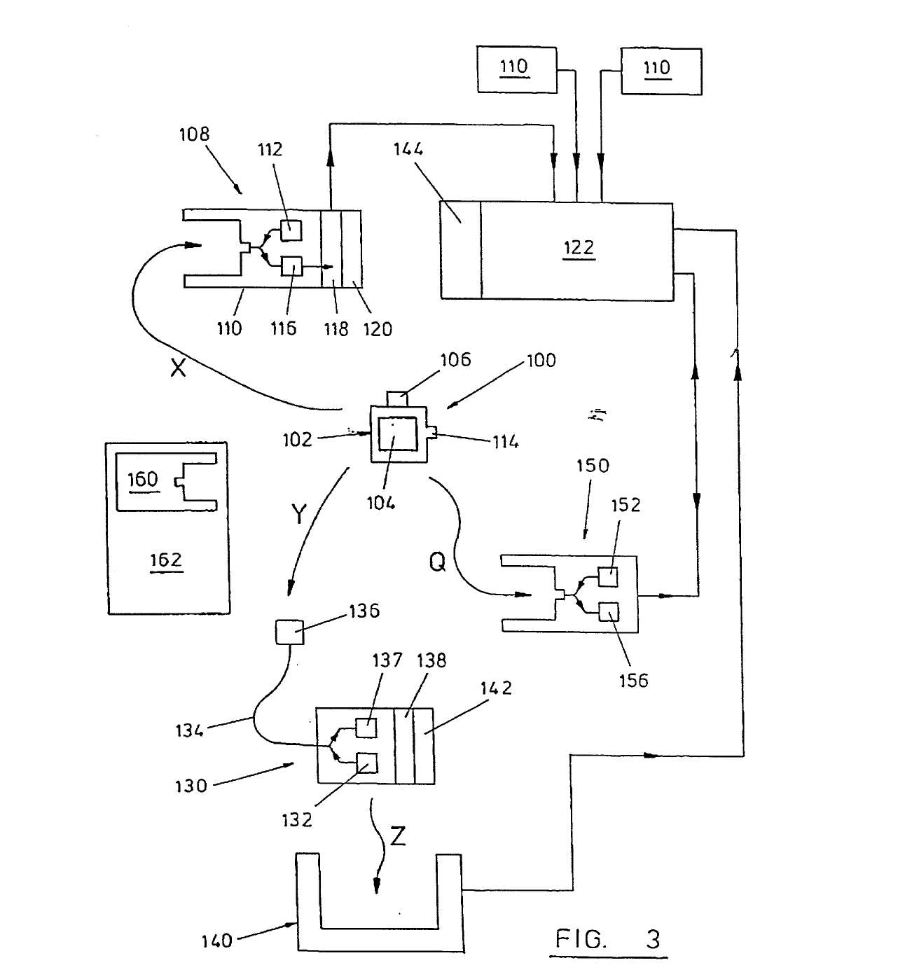

FIG. 3 illustrates a system including a personal dosimeter embodiment of the present invention and a variety of other options; and

FIG. 4 illustrates an area monitor embodiment of the present invention.

The present invention extensively uses storage phosphors in its techniques. It is known that phosphors, especially storage phosphors, may be used to provide image type information for incident radiation by subsequent stimulation of the storage medium to give luminescence.

The following electronic processes occur in phosphor materials

a) ionisation of a donor site within the phosphor above the valency band of the material by incident radiation;

b) electron transfer to a stable trap site which is below, for example, 1 to 2 eV below, the conduction band of the material;

c) liberation of the electron from the trap site by thermal stimulation or by photo stimulation, e.g. applying incident optical radiation;

d) decay of the liberated electron back onto a donor site thereby releasing a photon as luminescence.

Through this mechanism the invention uses phosphors to detect ionising radiation such as alpha, beta or gamma rays, X-rays, neutrons and ultraviolet radiation. The number of electrons excited and trapped is used as a measure of the intensity of the incident radiation and can itself be measured by detecting the number of photons released when the trapped electrons are photo stimulated.

Significantly phosphor materials may also undergo spontaneous luminescence whilst being irradiated by ionised radiation. This process involves the following electronic processes:

a) ionisation of the donor site within the phosphor by incident radiation;

b) direct recombination of an electron within a donor site thereby releasing a photon as luminescence.

Through this mechanism the number of excited electrons which spontaneously recombine with donor sites to cause luminescence can be taken as a measure of the intensity of the then incident radiation and these recombinations can be measured by detecting the number of photons released.

The trapped sites arising can be very stable and therefore reading by photo stimulation of the number of electrons trapped can take place many hours after the original ionisation. Furthermore, the total dose of radiation over a given period of time will be integrated in terms of the number of electrons excited.

A system according to the present invention suitable for i use as a criticality incident detection alarm system is designated generally by the reference numeral 1. On all nuclear installations where there is a risk of an uncontrolled criticality it is necessary to have criticality incident detector sensors. The system comprises a plurality of sensors 2 comprising storage phosphors The sensors 2 are positioned throughout an environment to be monitored. The environment may be a room, chamber, cell or a portion of such a volume. The sensors 2 are connected to a detection system 3 by optical fibres 4. Signal processing means 5 are connected to the detection system 3 and are in turn connected to an alarm system 6. The system further comprises a laser unit or other stimulator 7 connected to the sensors 2 by means of an optical fibre 10 and further by the optical fibres 4. Finally, the system comprises a control/diagnostic system 8 for interpreting measurements obtained from the device

The sensors 2 undergo electronic reactions of the type described hereinabove when subjected to ionising radiation, such as alpha, beta or gamma rays, X-rays and neutrons.

The detection system 3 measures spontaneous light emitted by the sensors 2. The light is conveyed through optical fibres 4 to the detection system 3 and a signal passes to processing means 5 as a result. If the level of emission from the sensors 2 is above a predetermined level, the signal processing means 5 will act as a trigger to trigger the alarm system 6 indicating that a criticality incident has occurred.

The sensors may be used to generate a single output, but more information on the level and location of the criticality incident can be gained by separately considering the sensors 2 relative to each other.

After a criticality incident, and also in non-criticality incident conditions, the sensors 2 may be stimulated by means of the laser system 7. This stimulation causes photons to be emitted from the sensors 2, the level of emission of the photons being dependent upon the level of radiation, by ionising radiation, to which the sensors 2 have previously been subjected. It is desirable to individually monitor the emissions from the individual sensors 2, although a common stimulating source 7 may be used. It is thus also possible to obtain detailed and accurate information relating to levels of radiation in a particular area after the radiation has been emitted.

By means of the control/diagnostic system 8, it is possible to interpret the levels of photon emission from the sensors 2 to obtain detailed information of how radiation levels have varied over time in a Particular area.

By stimulating the sensors at the end of a number of time periods the radiation exposure in those time periods can be individually determined. Calculations to give the dose can also be undertaken. 2-D and/or 3-D representations of dose and/or other information can be made based on the data measured by the system. Contour plots may be used to illustrate the results.

Post criticality investigations of this type are of great significance for a number of reasons. The more detailed information obtained can, for instance, be used to determine subsequent actions for the environment in question or for investigating the source and nature of the criticality.

Whilst the system described above may be used as a permanent monitoring system for an environment, either installed with the building or subsequently, the system is also suitable as a portable system for more short term use. The nature of the system and the ease with which it can be installed render it suitable for temporary use in an environment, such as a room or a small part thereof, where criticality incident monitoring is needed, but no such system is in-situ. This may be particularly applicable to decommissioning applications.

The configuration provided above is also suited to environmental monitoring applications. In such a case, periodic stimulated monitoring of the sensors 2 is used to determine the dose in the period since the last stimulation. This information from a number of such sensors 2 can be used to monitor a room, for instance, for variations in the radiation emissions. Significant changes over a period of time, or between readings, may act as a trigger for further investigations. The system need not employ monitoring of immediately arising luminescence, spontaneous luminescence, as used to monitor above for critically events.

The storage phosphor can be provided in a number of configurations and/or be monitored and/or interrogated in a number of ways, some of which are illustrated in FIGS. 2a to 2e.

In FIG. 2a the storage phosphor 50 is provided as a planar element with luminescent emissions being monitored on through, arrow A, the phosphor 50, relative to the direction of incidence (radiation or interrogating light), arrow B, and/or in a reflected direction, arrow C.

Similar directions apply, FIG. 2b, to an edge illuminated, arrow B, phosphor, with through luminescence, arrow A, reflected, arrow Cm, and transverse, arrow D luminescence being monitored.

In FIG. 2c, the phosphor is provided as a component of a fibre coil 52 with interrogating incident light, arrow B, giving monitored luminescent emission, arrow A, on through the fibre coil.

In FIG. 2d, the phosphor is provided as a component of a probe tip 54, with interrogating light, arrow B, being monitored by return light, arrow C, down the optical fibre 56.

In FIG. 2e, the phosphor is provided as part of a monolith 58, with illuminating light, arrow B, giving monitored through luminescence, arrow A; reflected luminescence, arrow C; and transverse luminescence, arrow D.

Equally the luminescence monitored, spontaneous and/or stimulated, and/or the stimulating light, can be obtained/applied in a variety of ways. Collection and/or delivery using single optical fibres, multiple optical fibres, mirror and lens systems, light guides and direct line of sight are all envisaged.

The detecting means used to convert the luminescent light collected into a further signal are envisaged as including photo-multiplier tubes, photo diodes, photocells, photovoltaic cells, phototransistors, photo resistors, charged coupled devices and pyro-electric detectors.

The stimulating means used to promote luminescence are envisaged as including optical stimulation sources, such as, lasers (including diode, solid state, dye, gas, chemical and excimer lasers), light emitting diodes, incandescent light bulbs, discharge lamps arc lamps and luminous chemical reaction sources.

Whilst the present invention is appropriate for use as a criticality incident alarm system, it is, however, also suitable as a dosimeter for monitoring levels of radiation to which personnel have been exposed, for example, in nuclear power stations or in medical applications.

An embodiment featuring such a device, within a more wide ranging system, is illustrated in FIG. 3. The dosimeter device 100 itself consists of a light tight container 102 which holds the storage phosphor 104. The container 102 also provides a clip 106 for mounting the device 100 on a person.

In its simplest form the device 100 is worn by the person in question throughout their duties until a given period of time has elapsed or there is other cause to investigate the dose received. At that stage the device 100 needs to be monitored.

The device 100 can be monitored according to a number of options, one or more of which may be provided within a system.

In a first option the device 100 is taken, ARROW X, to a location 108 which provides a monitoring station 110. The device 100 is plugged into the monitoring station 110 and investigated by it.

The investigation takes the form of a light source 112 which is applied to the phosphor 104 through an inlet 114. The inlet 114 is light tight in normal use. Luminescence induced in the phosphor 104 is detected through the inlet 114 by a photomultiplier 116 in the monitoring station 110. The processing means 118 in the monitoring station 110 calculate the dose received by the device 100, and hence the person, and perform any other calculations required.

The monitoring station 110 is provided with a readout 120 visible to the user relating to the dose.

Once the device 100 has been monitored it can be reused, due to the reusable nature of the storage phosphor; a photographic film can of course only be used once.

As an optional part of the system, the identity of the device 100 and the other information extracted are conveyed to a central location 122 operating a number of such monitoring stations 110. The central location 122 provides a processing capability and/or data storage and/or record keeping functions for the system.

The processing means 118 within the monitoring station may be replaced by the processing capability of the central location 122.

As another option for monitoring the device 100, the device 100 can be attached, ARROW Y, into a portable unit 130 which can be carried by the person using the device 100. The portable unit provides for interrogation of the device 100, periodically, by applying light from a source 132, through an optical fibre 134, which can be connected, via connector 136, to the device 100. It is then possible to detect the luminescent output using internal detector 137. The calculated result is indicated to the wearer on display 138 so allowing the wearer to take action according to the result in a prompt manner. The portable nature of the system in this format make it of great use in higher dose areas.

The results from the device 100, in-conjunctior with the unit 130, are stored internally in the unit 130 and in a further option feature are downloaded to the central location 122 upon the unit 130 being returned, ARROW Z, to a storage location 140 connected to the central location 122. Downloading to the central location 122 during use may be provided using radio or other remote transmission techniques.

The portable unit 130, in a further option, is provided with a criticality incident detection and alarm function. The internal detector 136 in this case monitors spontaneous luminescence arising in the phosphor 104 and, if this luminescence crosses a predetermined threshold, triggers an alarm 142 on the unit 130. An individual criticality incident detection system is provided as a result.

The alarm signal may additionally be transmitted immediately to the central location 122 to trigger the general alarm 144.

In a further, separate, option for the system the device 100 is inserted, ARROW Q, by its wearer into a access control unit 150. The access control unit 150 interrogates the device 100 using a light source 152 and detects the luminescence arising using detector 156. The calculated result, on its own or in combination with information from the central control location 122, determines whether the access requested is given to the person. In this way access which would be expected to cause the dose of that person to exceed a limit would be refused, for instance.

In a still further, separate, option for the system. monitoring units 160 are provided at an evacuation station 162. These units 160, interrogate the device 100 in the manner described above, as they arrive with their wearer and can be used to give a rapid evaluation of the dose received by individuals, for instance following a criticality incident, with that information being used to determine those individuals requiring immediate medical attention and those individuals who do not.

Whilst the device 100 has principally been described as a badge type device it should be appreciated that the small size of phosphor which still gives an effective device, coupled with the physical flexibility of such devices, allow them to be used as extremity monitors, for instance on fingertips. The device may be carried by the user in such cases or be carried by the gloves.

The device 100 could equally well be an item dosimeter, mounted on an item to monitor its dose with time.

The invention is also beneficially applicable to a variety of environmental monitoring applications, such as area monitoring, in-cell monitoring and remote monitoring, an example of which is illustrated in FIG. 4. In this case a series of sensors 200 are deployed within a radioactive cell 202 to provide monitoring of conditions within it. The sensors 200 are connected via optical fibre bundle 204 to a monitoring location 206 outside the cell 202. The nature of the optical fibres necessitate only a very small aperture in the shielded walls of the cell 202 and facilitate a non-linear passage there through, so avoiding problems with shine paths.

Environmental monitors of this type and/or the area monitor discussed above may provide periodic measurements of radioactivity and/or a record keeping for that data and/or an alarm function should a threshold value be crossed by a given reading or series of readings. Arrays of sensors or even individual sensors can be deployed using such systems. Embedded detectors in the walls of the environment may be deployed

In each of the forms discussed above the invention possesses a significant number of advantages over prior art detectors.

Firstly a consistent device type can be used in a wide variety of applications, simplifying manufacturing and operating procedures and training, aswell as reducing cost.

The device is also relatively cheap, allowing a very large number to be deployed, and yet successfully monitored using a more limited number of the more expensive monitoring components. The cost element is also improved by the reusable capability of the device.

The device also uses a detecting and storage component which is effective at very small sizes, is flexible and can be applied by simple techniques including painting or through the use of thin films.

The detecting and storage component is also capable of detecting the full energy spectrum required of it (gamma, beta, neutron) and can provide for selective detection in different sections of the spectrum. This may be achieved through the use of a series of phosphors with different thicknesses of shielding and/or the use of a sandwich structure with phosphor layers separate by layers of shielding, discrete interrogation being provided for the individual phosphor layers.

An important safeguard is also provided as when a sensor is interrogated a positive response, thereby confirming its functioning existence, is expected. There is no need to infer that the sensor is working.

1. A method of detecting radiation, the method comprising exposing a stimulable phosphor material to an environment, the environment potentially containing radiation, and further comprising stimulating the phosphor material to cause stimulated luminescence and detecting the stimulated luminescence arising from the stimulable phosphor and determining a function of the amount of radiation incident on the stimulable phosphor material from the detected stimulated luminescence, wherein stimulable phosphor material is provided in non-fixed positions during exposure to the environment.

2. A method according to claim 1 in which the stimulable phosphor is provided on a person during exposure to the environment.

3. A method according to claim 1 in which the function relates to the amount of incident radiation between stimulations.

4. A method of detecting radiation, the method comprising exposing a stimulable phosphor material to an environment, the environment potentially containing radiation, detecting luminescence arising from the stimulable phosphor and determining the amount of radiation incident on the stimulable phosphor material from the detected luminescence.

5. A method according to claim 4 in which the luminescence comprises stimulated luminescence.

6. A method according to claim 4 in which the stimulable phosphor material is provided at separate location(s) to the luminescence detecting means and/or processing means, the separate locations being separated by radiological shielding.

7. A method according to claim 4 in which the processing means calculate a function of the incident radiation based on the level of luminescence detected, the luminescence detected being the total luminescence output as a result of stimulation.

8. A method according to claim 7 in which the processing means may calculate dose and/or effective dose.

9. A method according to claim 7 in which the function of the incident radiation is compared with a threshold value, and if the threshold value is exceeded then an alarm is triggered.

10. A radiation detector, the detector comprising a stimulable phosphor material, the detector further being adapted to cooperate with luminescence detector means processing means for determining the amount of radiation incident on the stimulable phosphor material from the luminescence detected and arising from the stimulable phosphor, wherein the stimulable phosphor material is provided in a light tight container and the detector is provided with different thicknesses of shielding for the stimulable phosphor.

11. A radiation detection and measuring system comprising sensor means comprising a storage phosphor; stimulating means for stimulating the sensor means; and detection means for detecting signals emitted from the sensor means after stimulation, wherein the system comprises a stimulable phosphor provided in a container and carried by a person or on an item, a plurality of such containers being provided and wherein the detection means are connected to a central processing location and/or central data storage location and/or central control location.

12. A radiation detection and measuring systems according to claim 11 in which a plurality of containers are monitored simultaneously and/or sequentially.

13. A detector system according to claim 11 in which the detector includes one or more detecting components or sensors containing a stimulable phosphor, the one or more detecting components or sensors sharing luminescence detecting means and/or processing means.

14. A detector system according to claim 13 in which the detector, and/or component(s)/sensor(s) forming a part thereof, are provided in fixed position relative to the environment.

15. A detector system according to claim 13 in which the luminescence detecting means are provided as a separate unit from the sensor means.

16. A detector according to claim 11 in which the processing means are provided as a separate unit from the sensor means.

17. A detector according to claim 11 in which the stimulating means are provided a separate unit from the sensor means.
